(19) United States
(12) Patent Application Publication
(10) Pub. No.: US 2016/0148314 A1
(43) Pub. Date: May 26, 2016

(54) Systems and Methods to Enhance Capital Formation by Small and Medium Enterprises

(71) Applicant: HCFP, LLC, New York, NY (US)

(72) Inventor: Ira Scott Greenspan, New York, NY (US)

(21) Appl. No.: 14/950,351

(22) Filed: Nov. 24, 2015

Related U.S. Application Data
(60) Provisional application No. 62/084,181, filed on Nov. 25, 2014.

(51) Int. Cl. G06Q 40/06

(52) U.S. Cl. CPC G06Q 40/06

(57) ABSTRACT

The present disclosure provides, in an embodiment, a method for managing securities. The method may include creating a first entity for holding a first series of securities and creating a subsidiary entity associated with the first entity, where the subsidiary entity may be designed to hold a second series of securities. The method may further include offering publicly the first and second series of securities, wherein the first entity may holds rights to acquire part of the second series of securities. In addition, the method can also include performing business transactions through the first entity using the second series of securities held by the first entity.

### CROSS REFERENCE TO RELATED APPLICATIONS

This application claims priority to and benefit of Provisional Patent Application Ser. No. 62/084,181, filed on Nov. 25, 2014, the entirety of which is hereby incorporated herein by reference for the teachings therein.

### TECHNICAL FIELD

The presently disclosed embodiments relate generally to methods for effect initial public offerings, in particular, to initial public offering methods for small and medium enterprises.

### BACKGROUND

Changes in capital markets structure and the applicable regulatory framework have severely constrained access to the capital markets for small and medium enterprises or SMEs. These changes have made it extremely challenging for SMEs for effect initial public offerings. The decline in this segment of the initial public offering market has been a principal driver in the development, growth and acceptance of alternative pathways to access the public markets, including Special Purpose Acquisition Companies and other reverse merger vehicles and techniques. Although these have gained increasing mainstream acceptance in recent years, such alternatives remain subject to regulatory disfavor. Such disfavor reduces the effectiveness of these alternatives, thereby perpetuating constrained capital access for SMEs. In addition, new techniques have emerged or are being developed to access private capitals, including the development of private markets.

Because SMEs are widely considered to be drivers of economic growth and job creation, a number of legal and regulatory initiatives, such as the JOBS Act, have been undertaken which have been designed to facilitate capital formation for SMEs. The implementation of some of these initiatives, or aspects thereof, has been subject to various delays. Use of some of these has also been hampered by uncertainty of certain aspects of the regulatory framework. Until these and other initiatives are fully implemented or otherwise utilized, capital access for SMEs is likely to remain constrained. As a result, SMEs have a keen interest in novel methodologies that are designed to capitalize on existing regulatory and capital markets frameworks or for otherwise accessing capital.

### BRIEF SUMMARY OF INVENTION

According to embodiments illustrated herein, there is provided a method for managing securities. The method may include creating a first entity for holding a first series of securities and a subsidiary entity associated with the first entity, where the subsidiary entity may be designed to hold a second series of securities. The method may further include offering publicly the first and second series of securities, wherein the first entity holds rights to acquire part of the second series of securities. The method can also include performing business transactions through the first entity using the second series of securities held by the first entity.

### BRIEF DESCRIPTION OF DRAWINGS

Illustrative, non-limiting example embodiments will be more clearly understood from the following detailed description taken in conjunction with the accompanying drawings.

FIG. 1 depicts a securities holding system according the various embodiments presented herein.

FIG. 2A and FIG. 2B depict corporate entities performing public offerings.

FIG. 3A and FIG. 3B illustrate the different types of securities available at the time of a public offering and after the public offering.

FIG. 4A and FIG. 4B depict the first corporate entity acquiring business entities.

FIG. 5A and FIG. 5B depict the transferring of security interests from business combinations.

FIG. 6 depicts a method for managing security interests in accordance with various embodiments illustrated herein.

### DETAILED DESCRIPTION OF SPECIFIC EMBODIMENTS

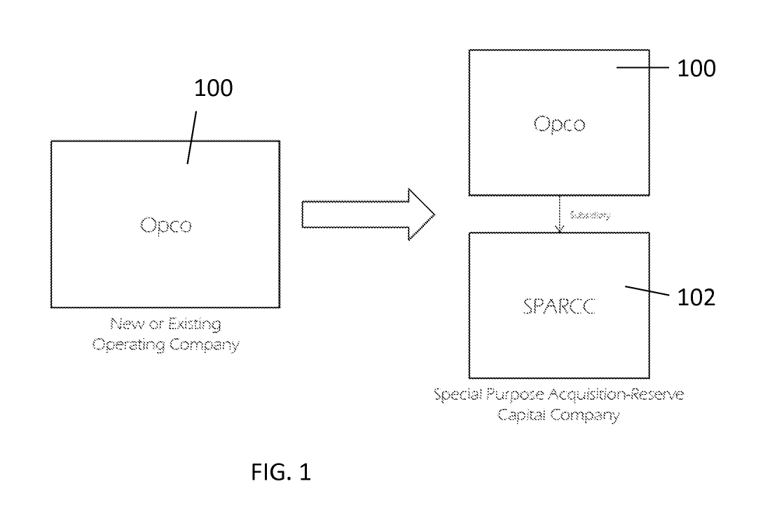

Various embodiments of the present disclosure can include a securities holding system having two corporate entities, a new or existing operating company, the Opco 100, and a subsidiary of the Opco, as illustrated in FIG. 1. The subsidiary entity can be referred to as a Special Purpose Acquisition-Reserve Capital Company or SPARCC™ 102. The method of this system can involve the offering of securities in one or both companies.

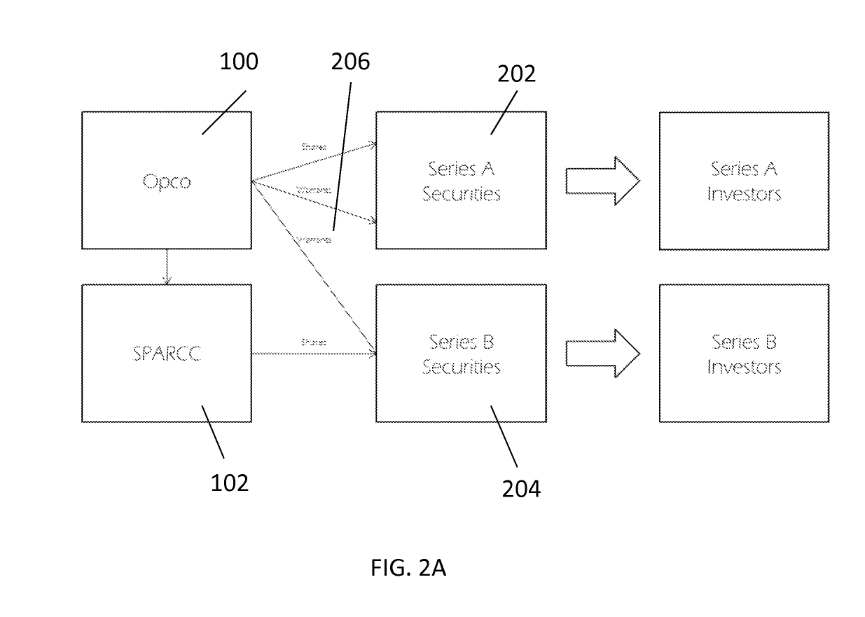

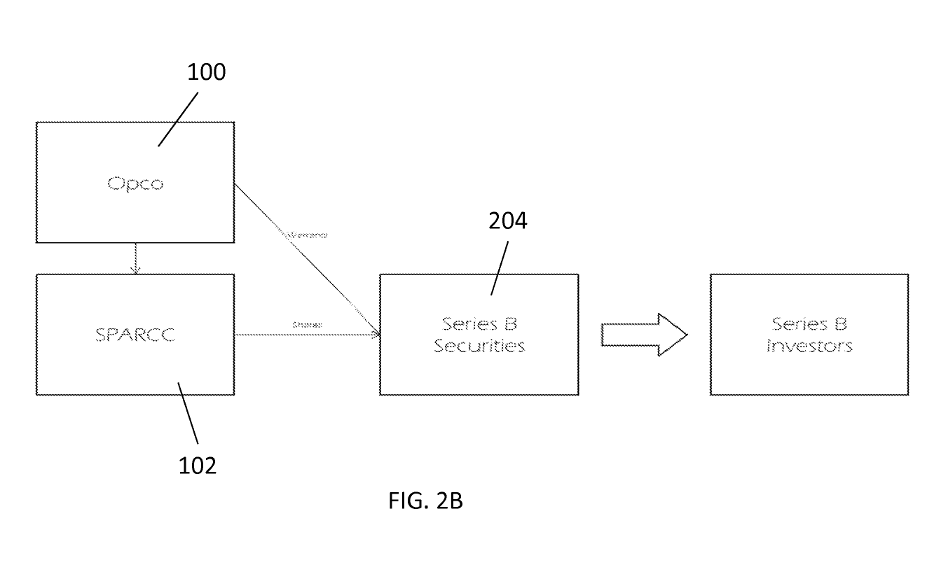

Referring now to FIG. 2A, in some embodiments, the Opco 100 may create the subsidiary SPARCC 102 and both companies may concurrently offer securities for sale—Series A Securities 202 by the Opco 100 and Series B Securities 204 by the SPARCC 102. The Series B Securities 204 may include one or more components that reference securities in the Opco 100 such as warrants 206 to purchase shares in the Opco 100.

In some embodiments, as illustrated in FIG. 2B, the Opco 100 may create the subsidiary SPARCC 102 but only the SPARCC 102 may undertake an offering of Series B Securities 204 (which again, may include components that references securities in the Opco 100). In this embodiment, the Opco 100 itself can have the option to not directly undertake an offering.

In the embodiment illustrated in FIG. 2A, the Opco 100 may issue Series A Securities 202 and the SPARCC 102 may issue Series B Securities 204. The proceeds of the Series A Securities 202 can be used to fund the capital requirements of the Opco 100, including for working capital and general corporate purposes, which may include acquisitions. These proceeds may also fund the costs of the offering of Series B Securities 204 by the SPARCC 102 as well as certain other expenses.

In some embodiments, the sole business purpose of the SPARCC 102 can be to hold the proceeds from the sale of the Series B Securities. The SPARCC 102 can have the option to not to engage in any operating activities other than those required (i) as a result of holding the proceeds from the sale of the Series B Securities in trust and (ii) as a result of any status as a public reporting company upon consummation of the offering, such as filing periodic reports with the appropriate regulatory agency.

The proceeds from the sale of the Series B Securities sold by the SPARCC 102 may be reserved for use in connection with business transactions such as a business combination for effect by the Opco 100. In order to use the proceeds, the target of the business combination may preferably have a fair market value equal to or greater than a certain threshold defined at the time of the offerings. The Opco 100 may also wish to complete the business combination by a date specified at the time of the offerings.

The SPARCC 102 itself may have the option to not to engage in any type of merger or acquisition while holding the proceeds from the sale of the Series B Securities in the offering and can choose not to be a party to the business combination itself. Should the nature of the business combination require the Opco 100 to use a subsidiary to consummate the transaction, the Opco 100 can form a new subsidiary to complete the transaction. For example, this situation may arise if the Opco 100 were to seek to engage in any type of triangular merger whereby the target business merges with a subsidiary of the Opco 100 and thereby become a wholly owned subsidiary of the Opco 100.

The proceeds from the sale of the Series B Securities by the SPARCC 102 may be placed in a segregated account, such as a trust account, promptly upon closing of the offerings for the benefit of the holders of the Series B Securities. These proceeds may be held in such account until the earlier of the date on which the Opco 100 completes a business combination or a date that is a specified number of months after consummation of the offerings. If the Opco 100 has not completed a business combination by the expiration of the specified time period, the SPARCC 102 will automatically redeem its securities sold in the offering for a pro rata portion of the funds held in the SPARCC's trust account.

In some embodiments, the SPARCC 102 may be created as a wholly owned subsidiary of the Opco 100. The Opco 100 may own all of the outstanding shares of common stock of the SPARCC 102, which can generally be its only class of securities outstanding prior to the offerings. Upon consummation of the offerings, the Opco 100 may continue to own 100% of the outstanding common stock of the SPARCC 102 and investors of the Series B Securities may own 100% of the preferred stock or other senior securities, such as debt securities. The Opco 100 can waive any rights in and to the funds held in the SPARCC's trust account in the event the Opco 100 is unable to complete a business combination within the specified time period. If the Opco 100 does not complete a business combination within such required time period, the Opco 100 will either dissolve the SPARCC 102 following distribution of the funds held by it in trust or maintain its existence as an Opco 100 subsidiary if the Opco 100 has any need at such time for a non-operating subsidiary.

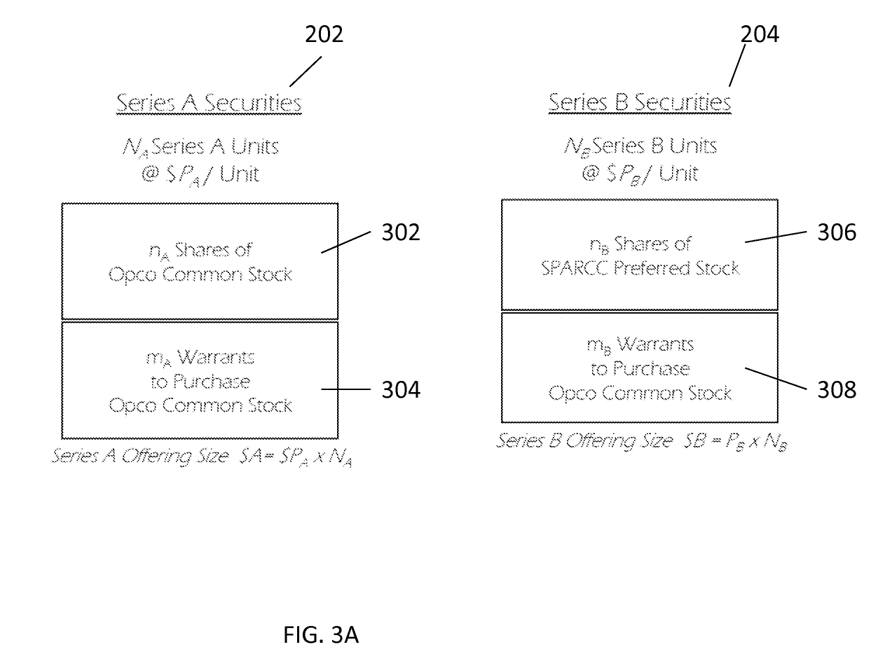

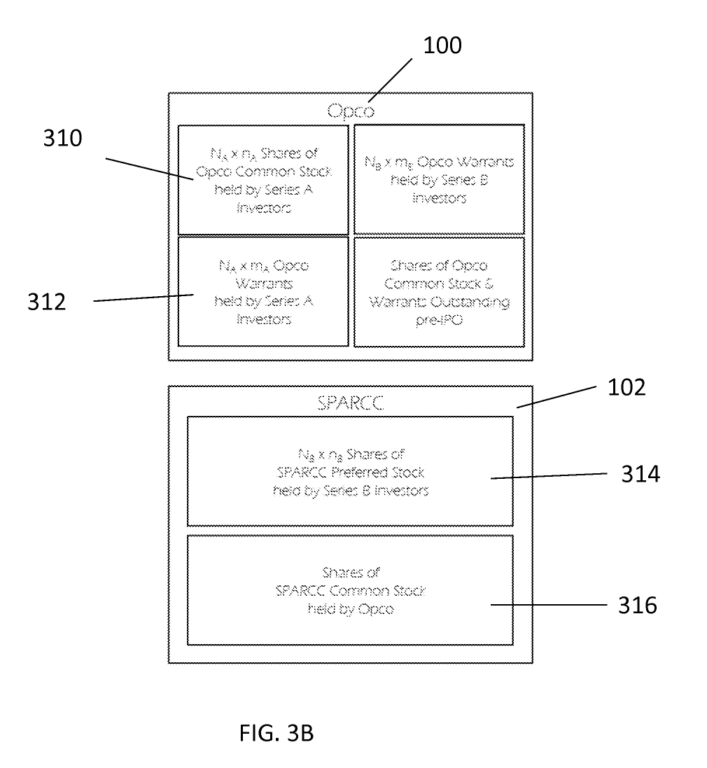

FIG. 3A and FIG. 3B illustrate the different types of securities available at the time of offering, and also securities held by Opco 100 and SPARCC 102 after the offering. Referring now to FIG. 3A, at the time of the offering, Series A Securities may include n_{A} share of Opco Common Stock 302 and m_{A} Warrants to purchase Opco Common Stock 304. Meanwhile, the Series B Securities may include n_{B} shares of SPARCC Preferred Stock 306 and m_{B} Warrants to purchase Opco Common Stock 308. Referring now to FIG. 3B, after the offering has completed, the Opco 100 may have in its possession securities such as N_{A}×n_{A} shares of Opco Common Stock held by Series A Investors 310 and N_{A}×m_{A} Opco Warrants held by Series A Investors 312. In addition, the SPARCC may have in its possession N_{B}×n_{B} shares of SPARCC Preferred Stock held by Series B Investors 314 and shares of SPARCC Common Stock held by Opco 316.

In some embodiments, the Opco's 100 failure to complete a business combination within the required period of time, the redemption of the SPARCC's 102 preferred stock or other senior securities and the SPARCC's 102 potential subsequent dissolution may or may not affect the operations of the Opco 100, which may continue in existence as an operating company.

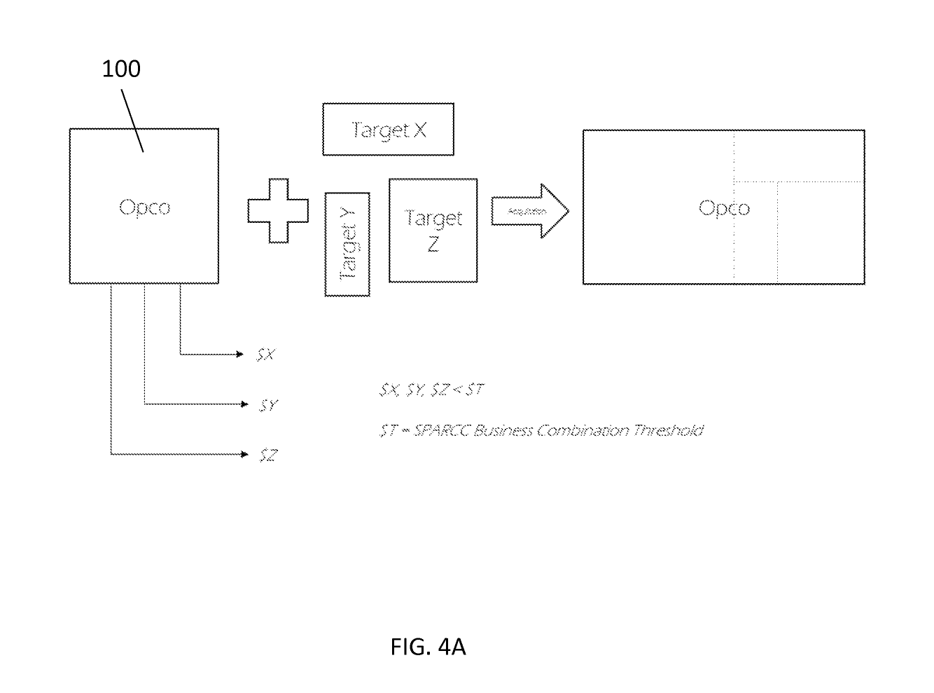

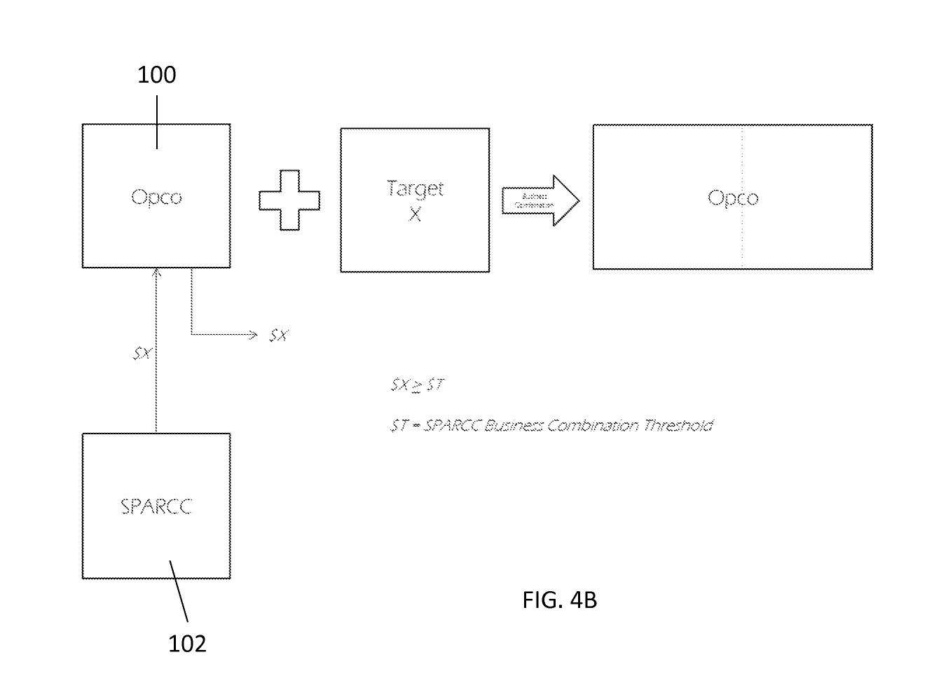

Prior to any distribution of funds held in trust by the SPARCC 102 or any dissolution of the SPARCC 102, the Opco 100 may be free to affect one or more acquisitions as long as the fair market value of each acquisition falls below the business combination threshold established at the time of the offerings, as illustrated in FIG. 4A. In addition, it is free to pursue any type of acquisition or business combination of any size following the distribution of funds held in trust by the SPARCC 102 or any dissolution of the SPARCC 102, as illustrated in FIG. 4B.

The Opco 100 may choose to only offer its stockholders the opportunity to vote on an acquisition, business combination, or post-SPARCC 102 transaction if required by applicable corporate law. For instance, asset acquisitions and stock purchases would not typically require stockholder approval while direct mergers with the Opco 100 in which the Opco 100 does not survive would. In such a case, generally only holders of any of the Opco's 100 common stock, including any included in the Series A Securities sold in the offerings, may be entitled to vote on such transaction. Holders of the SPARCC's common stock and preferred stock or other senior securities, including those contained in the Series B Securities sold in the offerings, may not have any rights to vote on any acquisition or business combination the Opco 100 seeks to consummate since the SPARCC 102 may not be a party to any such transaction.

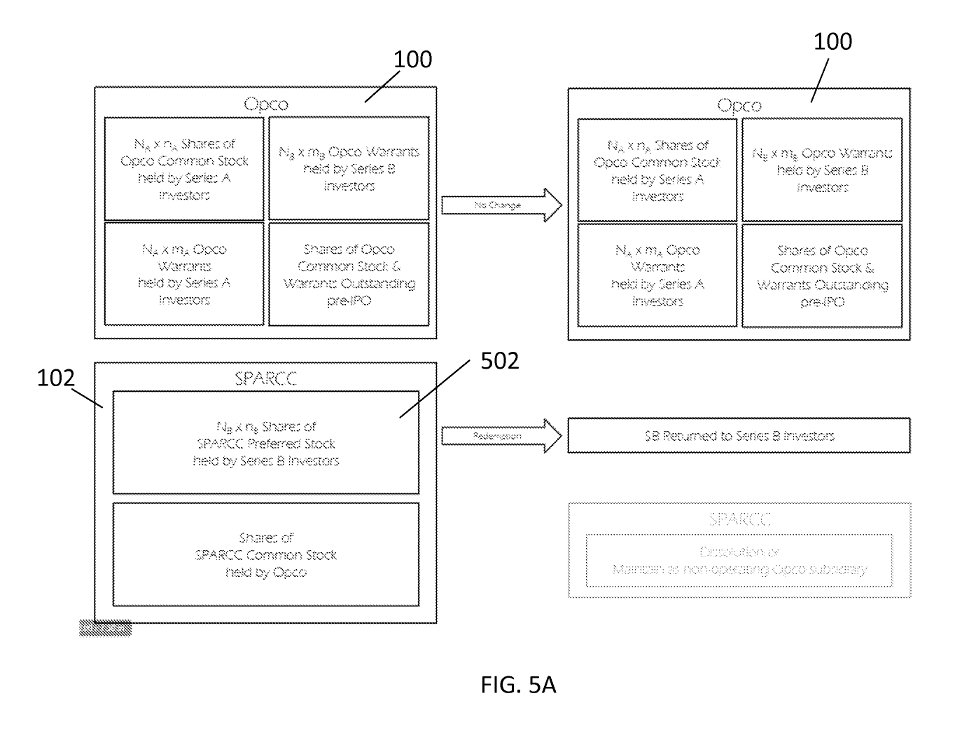

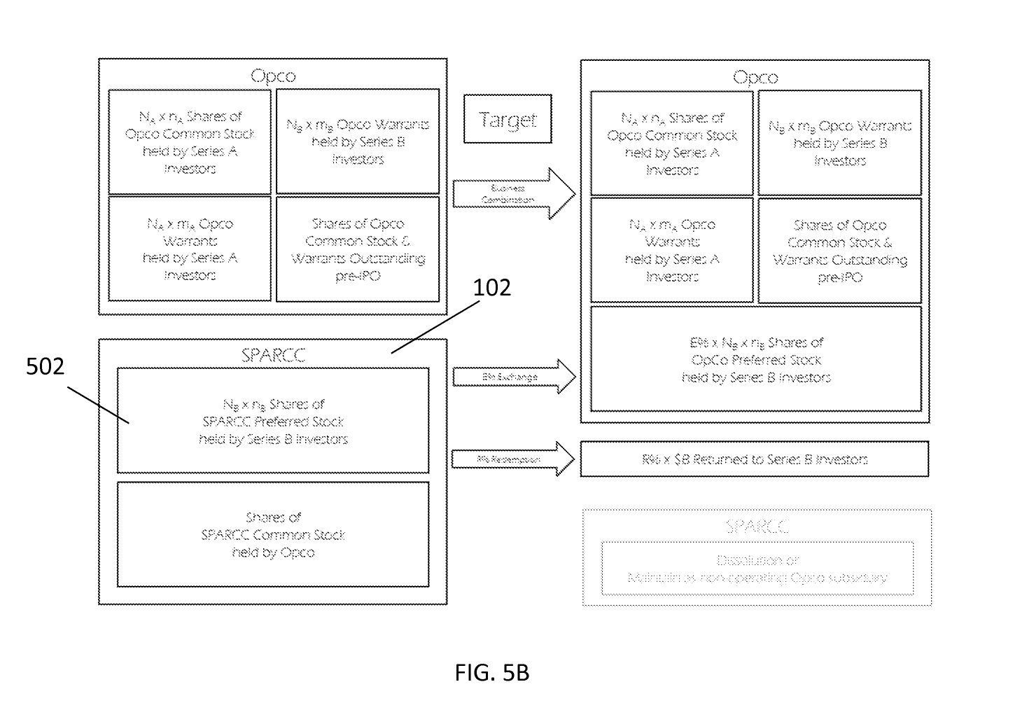

With respect to a business combination, prior to consummating such transaction, as illustrated in FIG. 5A, the Opco 100 may choose to file an appropriate registration statement with an appropriate regulatory agency or use any other applicable mechanism pursuant to which the Opco 100 will offer to exchange each share of the SPARCC's Preferred Stock 502 or other senior securities sold in the offerings for securities of the Opco 100. If a holder of the SPARCC's Preferred Stock 502 or other senior securities does not accept an exchange offer, upon consummation of the business combination, such holder's shares of the SPARCC's Preferred Stock 502 or other senior securities may automatically be redeemed for a portion of the trust account, which may be approximately the dollar amount paid per unit of Series B Securities sold in the offerings.

As a result, as illustrated in FIG. 5B, upon consummation of the business combination, all of the shares of preferred stock or other senior securities of the SPARCC 102 sold in the offering may either be exchanged or redeemed. Regardless of whether a holder of the SPARCC's Preferred Stock 502 or other senior securities sold in the offerings accepts the above-referenced exchange offer, that holder may continue to own any warrant or warrants included in the Series B Securities sold in the offerings, to the extent such stockholder has not previously exercised or sold any such warrant or warrants. In some embodiments, the Opco 100 may proceed with a business combination when the holders of a certain percentage, specified at the time of the offering, of the SPARCC's 102 preferred stock or other senior securities agree to exchange such securities for securities of the Opco 100 as described above.

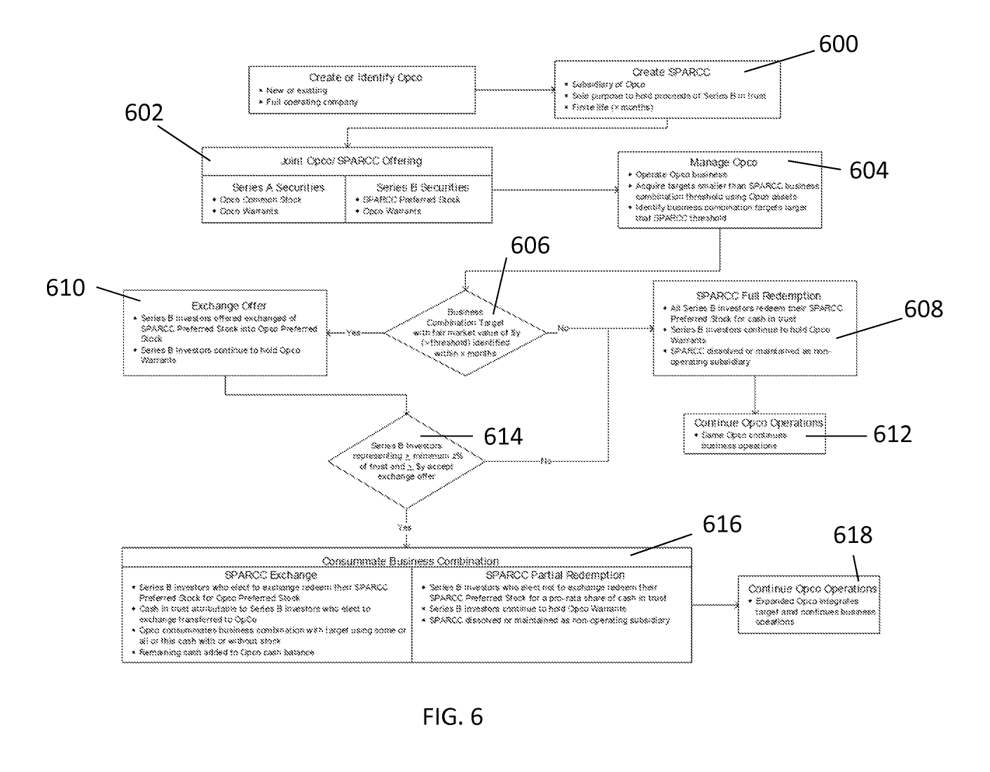

Referring now to FIG. 6, illustrated is a business method in accordance with various embodiments illustrated herein. At step 600, a SPARCC may be created as a subsidiary of an Opco. Subsequently, a joint Opco and SPARCC offering may be held which may include Series A and Series B securities, as illustrated at step 602. At step 604, the Opco may be managed to acquire targets smaller than SPARCC business combination threshold using Opco assets. Where at step 606, business combination targets with their fair market values may be identified. Then the method may proceed to step 608 where a SPARCC full redemption may be performed, followed by a continued Opco operations at step 612. Or alternatively, the method may proceed to step 610 where an exchange offer may be performed. Subsequently, Series B investors may have the option to accept exchange offers, as illustrated in step 614. If an exchange offer was accepted, business combination can be consummated in step 616. In some embodiments, Opco operations may be continued, as illustrated in box 618.

What is claimed is:

1. A method for managing securities:
creating a first entity for holding a first series of securities;
creating a subsidiary entity associated with the first entity, where the subsidiary entity is designed to hold a second series of securities;
offering publicly the first and second series of securities, wherein the first entity holds rights to acquire part of the second series of securities; and
performing business transactions through the first entity using the second series of securities held by the first entity.

2. The method of claim 1, wherein the step of performing business transactions further including the subsidiary entity redeeming the second series of securities.

3. The method of claim 1, wherein the step of performing business transactions further including dissolving the subsidiary entity.
